(19) United States
(12) Patent Application Publication
(10) Pub. No.: US 2026/0253065 A1
(43) Pub. Date: Aug. 27, 2026

(54) DEVICES, SYSTEM AND METHOD FOR ELECTRONIC CASHLESS PAYMENT

(71) Applicant: Bundesdruckerei GmbH, Berlin (DE)

(72) Inventors: Christoph BÖSCH, Nuthetal (DE); Sven MARSING, Bernau (DE); Florian PETERS, Berlin (DE)

(21) Appl. No.: 18/858,613

(22) PCT Filed: Mar. 23, 2023
(86) PCT No.: PCT/EP2023/057540

§ 371 Date: Oct. 21, 2024

(30) Foreign Application Priority Data
Apr. 22, 2022 (DE) 10 2022 109 813.3

(51) Int. Cl. G06Q 20/38; H04L 9/32

(52) U.S. Cl. CPC G06Q 20/3825; G06Q 20/389; H04L 9/3221; H04L 2209/56

(57) ABSTRACT

A data communication may include at least one processor configured to execute a payment application and an ID application, and a communication interface configured to communicate with a trust center server arrangement and a money ledger. The payment application may be configured to send a transaction ID and a decentralized identity, DID, of a user of the device to a payment agent of the trust center server arrangement. The ID application may be configured, in response to a request containing the DID, to send signed user credentials of the user of the data communication device to an ID agent of the trust center server arrangement. The payment application may be further configured to receive a signature of the transaction ID from the payment agent of the trust center server arrangement and to send the signature of the transaction ID to the money ledger.

### CROSS-REFERENCE

The present application is the national phase entry under 35 U.S.C. 371 of International Patent Application No. PCT/EP2023/057540 by BÖSCH et al., entitled “DEVICES, SYSTEM AND METHOD FOR ELECTRONIC CASHLESS PAYMENT”, filed Mar. 3, 2023, and claims the benefit of German Patent Application No. 10 2022 109 813.3 by BÖSCH et al., entitled “VORRICHTUNGEN, SYSTEM UND VERFAHREN ZUM ELEKTRONISCHEN BARGELDLOSEN BEZAHLEN”, filed Apr. 22, 2022, each of which is assigned to the assignee hereof and is incorporated by reference in its entirety.

### TECHNICAL FIELD

The present disclosure relates to devices, a system and methods for electronic cashless payment.

### BACKGROUND

As digitalization increases, cashless payment instruments are increasingly coming to the fore, in particularly those based on electronic payment processing methods. Cashless payment transactions involve a transfer of payment means without the transfer of cash. Cash payments involve an exchange of cash, i.e. banknotes or coins, between the payer and the payee, whereas cashless payments do not involve such an exchange of cash.

Cash, for example, has the advantage that it is available to everyone and may be used quickly and anywhere. For example, no bank account is required for cash-based payment processing. In addition, cash is often valued by its owners as a way to store value. Cashless payment methods, on the other hand, have the advantage that they enable efficient payment processing even when the payer and the payee are in distant locations, as is the case with purchases over the Internet, for example.

In cash transactions, the anonymity of the parties involved is essentially preserved. Cashless electronic payment methods may also be carried out anonymously, but it may be necessary, for example due to legal regulations, to gather the identities of the parties involved, i.e. the payer and the payee, above certain amounts so that they can be traced. In the case of cashless electronic payment methods based on a blockchain, such as Bitcoin, such a possibility of tracking is generally not available.

### SUMMARY

It is the object of the present disclosure to create a concept for electronic cashless payment which, when needed, allows tracking of the identities of the parties involved, i.e. the payer and the payee.

This object is achieved by the features of the independent claims. Advantageous examples are the subject of the dependent patent claims, the description and the figures.

The examples of the disclosure described here are based on the idea that, in order to execute a cashless electronic transaction using a data communication device, for example a smartphone, a trust service provider, in particular a trust center, verifies the identity of the payer, stores the identity of the payer in a database together with a transaction ID and digitally signs the transaction ID so that the signed transaction ID is stored on a money ledger by the data communication device. According to an example, the link of a transaction to the identity of the payer may be carried out by the trust center if the amount of the transaction exceeds a threshold. For a transaction whose amount is not higher than the threshold, the data communication device may store the transaction without involving the trust center, i.e. the transaction may be carried out completely anonymously. By linking a transaction to the identity of the payer by the trust center, the anonymity of a transaction on the money ledger may be maintained but may be tracked when needed.

According to a first aspect, a data communication device is provided for executing an electronic payment transaction. The data communication device comprises at least one processor, which is configured to execute a payment application and an ID application, as well as a communication interface, which is configured to communicate with a trust center server arrangement and a money ledger. The payment application is configured to send a transaction ID and a decentralized identity, DID, of a user of the data communication device to a payment agent of the trust center server arrangement. The ID application is configured, in response to a request containing the DID from an ID agent of the trust center server arrangement, to send signed user credentials of the user of the data communication device to the ID agent of the trust center server arrangement. The payment application is further configured to receive a signature of the transaction ID from the payment agent of the trust center server arrangement and to send the signature of the transaction ID to the money ledger in order to register the electronic payment transaction with the signature of the transaction ID on the money ledger.

In an example, for executing a further electronic payment transaction whose amount is less than a threshold value, the payment application is configured to send a further transaction ID of the further electronic payment transaction without a signature of the further transaction ID to the money ledger in order to register the electronic payment transaction with the further transaction ID and without a signature of the further transaction ID on the money ledger.

In an example, the payment application is further configured to generate the transaction ID and/or to receive the DID of the user of the data communication device from the ID application upon request.

In an example, the ID application is further configured to send zero-knowledge proof data to the ID agent of the trust center server arrangement in response to the request of the ID agent of the trust center server arrangement in order to verify the signed user credentials of the user of the data communication device.

In an example, the payment application is further configured to send a further DID of a further user of a further data communication device together with the transaction ID and the DID of the user of the data communication device to the payment agent of the trust center server arrangement. In an example, the further user of the further data communication device is the payment recipient.

In an example, the data communication device is a mobile and portable data communication device, in particular a smartphone.

According to a second aspect, a method is provided for operating a data communication device for executing an electronic payment transaction, wherein the data communication device comprises at least one processor, which is configured to execute a payment application and an ID application, and a communication interface, which is configured to communicate with a trust center server arrangement and a money ledger. The method comprises the following steps:
sending a transaction ID and a decentralized identity, DID, of a user of the data communication device from the payment application to a payment agent of the trust center server arrangement;
sending signed user credentials of the user of the data communication device from the ID application to an ID agent of the trust center server arrangement, in response to a request containing the DID from the ID agent of the trust center server arrangement;
receiving a signature of the transaction ID from the payment agent of the trust center server arrangement by the payment application; and
sending the transaction ID signature from the payment application to the money ledger in order to register the electronic payment transaction with the signature of the transaction ID on the money ledger.

According to a third aspect, a trust center server arrangement is provided for executing an electronic payment transaction. The trust center server arrangement comprises at least one processor, which is configured to execute a payment agent and an ID agent, a communication interface, which is configured to communicate with a data communication device, and a memory for storing electronic data. The payment agent is configured to receive a transaction ID and a decentralized identity, DID, of a user of the data communication device from a payment application of the data communication device. The ID agent is configured, in response to a request from the payment agent containing the DID for user credentials of the user of the data communication device, to obtain the signed user credentials of the user of the data communication device from an ID application of the data communication device. The payment agent is further configured to obtain the user credentials of the user of the data communication device and to store them together with the transaction ID in the memory. The payment agent is further configured to sign the transaction ID and to send the signed transaction ID to the payment application of the data communication device in order to be able to register the electronic payment transaction with the signature of the transaction ID on a money ledger.

In an example, the communication interface is further configured to communicate with an ID ledger and the ID agent is further configured to receive zero-knowledge proof data from the ID application of the data communication device and to verify the signed user credentials of the user of the data communication device by means of the zero-knowledge proof data and the ID ledger.

According to a fourth aspect, a method is provided for operating a trust center server arrangement for executing an electronic payment transaction, wherein the trust center server arrangement comprises at least one processor, which is configured to execute a payment agent and an ID agent, a communication interface, which is configured to communicate with a data communication device, and a memory for storing electronic data. The method comprises the following steps:
receiving a transaction ID and a decentralized identity, DID, of a user of the data communication device from a payment application of the data communication device by the payment agent;
obtaining signed user credentials of the user of the data communication device from an ID application of the data communication device by the ID agent, in response to a request from the payment agent containing the DID for the user credentials of the user of the data communication device;
obtaining the user credentials of the user of the data communication device by the payment agent;
storing the user credentials of the user of the data communication device together with the transaction ID by the payment agent in the memory; and
sending the signed transaction ID from the payment agent to the payment application of the data communication device in order to be able to register the electronic payment transaction with the signature of the transaction ID on a money ledger.

According to a fifth aspect, a system is provided for executing an electronic payment transaction, wherein the system comprises a plurality of data communication devices according to the first aspect and a trust center server arrangement according to the third aspect.

The different aspects of the disclosure may be implemented in hardware and/or software.

### BRIEF DESCRIPTION OF THE DRAWINGS

Further examples are explained in more detail with reference to the attached figures. It is shown in:

FIG. 1 a schematic diagram of a system for electronic payment according to an example with a data communication device according to an example and a trust center server arrangement according to an example;

FIG. 2 a signaling diagram, which illustrates the interaction of the components of the system of FIG. 1 according to an example;

FIG. 3 a flow chart, which illustrates steps of a method for operating a data communication device according to an example; and

FIG. 4 a flow chart, which illustrates steps of a method for operating a trust center server arrangement according to an example.

### DETAILED DESCRIPTION

Elements of the examples described in detail below which correspond to one another are identified by the same reference signs.

A “blockchain” is understood here and in the following to be an ordered data structure, which includes a large number of data blocks linked together. In particular, a blockchain is understood to be an ordered data structure, in which each of the blocks (except the first block) includes a check value, for example a hash value, of its previous block and thus the validity of all of its previous blocks may be checked and, if necessary, confirmed using each block. The concept of the blockchain was described, for example, in 2008 in a white paper under the pseudonym Satoshi Nakamoto on Bitcoin (“Bitcoin: Peer-to-Peer Electronic Cash System” (https://bitcoin.org/bitcoin.pdf)). The blockchain described therein consists of a series of data blocks, in which one or more entries or transactions are summarized and provided with a checksum in the form of a hash value. Additional blocks of the blockchain are generated, for example, in a computationally intensive process that is also known as mining. These additionally generated blocks are then added to the blockchain and are distributed via a network to all participants or nodes of the network. examples can have the advantage that the blockchain offers a high degree of security against subsequent manipulation by storing cryptographic checksums, i.e. hash values, of the previous block in the subsequent block. The chaining of the blocks may then be checked using these root hash values. Each block of the blockchain contains the hash of the entire previous block header in its header. This clearly defines the order of the blocks and creates a chain structure. By chaining the individual blocks together in this way, it is practically impossible to subsequently modify previous blocks or individual entries, since this would require the hash values of all subsequent blocks to be recalculated in a short period of time.

According to an example, the blockchain is a blockchain, in which only a selected group of participants has authorization to add valid blocks. Such authorization may be proven, for example, by means of a signature using a private cryptographic key. The private cryptographic key may belong to an asymmetric key pair, which also includes a public cryptographic key, with which the signature may be verified. The asymmetric key pair may also be assigned, for example, a certificate that proves the authorization to create a valid block of the blockchain. This certificate may also be assigned to a PKI that proves the authenticity of the certificate. According to another example, a public key may be stored in the blockchain in an initialization entry for additional participants who are to be added to the selected group. These public keys may be used to check whether signatures of blocks and thus the corresponding blocks themselves are valid. Public keys of original participants in the selected group may, for example, be stored in a genesis block of the blockchain.

For example, the blockchain managed by a central bank is a public blockchain that is managed on the blockchain servers of the central bank. For example, new blocks are only entered by these blockchain servers managed by the central bank. In this case, computationally intensive processes may be eliminated when adding additional blocks. For example, all that is required to add additional blocks is a signature with a signature key assigned to the central bank.

A trust center represents a trusted third party that may certify the identity of the communication partner in electronic communication processes. For example, in electronic communication in connection with electronic signatures, a trust center may issue certificates that may be used to certify the identity of the communication partner.

A “communication interface” or “communication interface” is understood here to be, for example, an interface, via which data may be received and sent, wherein the communication interface may be configured contact-based or contactless.

Communication may take place, for example, via a network. A “network” is understood here to mean any transmission medium with a connection for communication, in particular a local connection or a local network, in particular a local area network (LAN), a private network, in particular an intranet, and a digital private network (Virtual Private Network VPN). For example, a computer system may have a standard radio interface for connection to a WLAN. It may also be a public network, such as the Internet. Depending on the example, this connection may also be established via a mobile network.

A “processor” is understood here and in the following to mean a logic circuit that serves to execute program instructions. The logic circuit may be implemented on one or more discrete components, in particular on a chip. A processor comprises, for example, an arithmetic unit, a control unit, registers and data lines for communication with other components. In particular, a “processor” is understood to mean a microprocessor or a microprocessor system comprising several processor cores and/or several microprocessors. The processor is configured to execute program instructions that are stored, for example, in a memory in order to execute the operations and methods described herein.

A “memory” is understood here to mean in particular a non-volatile memory. A “non-volatile memory” is understood here to mean, for example, an electronic memory for the permanent storage of data. A non-volatile memory may be configured as a non-changeable memory, which is also referred to as a read-only memory (ROM), or as a changeable memory, which is also referred to as a non-volatile memory (NVM). In particular, this may be an EEPROM, for example a flash EEPROM, referred to as flash for short. A non-volatile memory is characterized by the data stored on it being retained even after the power supply is switched off.

A “protected memory area” is understood here to be an area of an electronic memory to which access, i.e. read access or write access, is only possible via a processor of a security element. For example, no external access is possible to the protected memory area, i.e. data may neither be brought in from the outside nor output to the outside. For example, data may be read out from the protected memory area via the processor. For example, data may be brought into the protected memory area from the outside via the processor. According to examples, access from or via the processor coupled to the memory is only possible if a condition required for this is met. This may be, for example, a cryptographic condition, in particular successful authentication and/or a successful authorization check. Such a check may, for example, be based on an electronic signature with a signature key.

Asymmetric key pairs are used for a variety of cryptosystems and also play an important role in the signature of electronic data. An asymmetric key pair consists of a public key, which is used to encrypt and/or decrypt data and may be passed on to third parties, and a private key, which is used to encrypt and/or decrypt data and must generally be kept secret. The public key enables anyone to encrypt data for the owner of the private key and to verify digital signatures created with the private key. A private key enables its owner to decrypt data encrypted with the public key or to create digital signatures. A signature created with a private key may be verified with the associated public key.

The creation of a digital signature, hereinafter also referred to simply as a “signature”, is a cryptographic process in which an additional data value, which is referred to as a “signature”, is calculated for any data. A signature may, for example, be a hash value of the source data encrypted with a private cryptographic key.

A security element is understood here to be, for example, an electronic component that includes a processor and a memory, and to which only certain predefined accesses are permitted. For example, only certain data values that are stored in certain areas of the memory may be read. For example, data values stored in a protected memory area cannot be read. For example, to write a data value into the memory of the security element, a digital signature is required, the verification key of which is stored in the security element. For example, only the processor has write permissions to write data into a protected memory area.

The security element further provides, for example, cryptographic core routines in the form of cryptographic program instructions with cryptographic algorithms for signature creation and/or verification, key generation, and/or random number generation and may further serve as a secure storage for cryptographic keys.

For example, at least parts of the security element are signed. Before the security element is used, it is verified whether the signature or signatures are valid. If one of the signatures is not valid, the use of the security element is blocked, for example.

For example, the security element has physically limited access options. In addition, the security element may have additional measures against misuse, in particular against unauthorized access to data in the memory of the security element. For example, the means for protecting the security element against unauthorized manipulation include mechanical means that are intended to prevent the security element or its parts from being opened, for example, or that render the security element unusable if an attempt is made to intervene in it, for example by causing data loss. For example, at least parts of the security element may be enclosed, cast and/or laminated in a material, the attempted removal of which leads to the inevitable destruction of the corresponding parts of the security element.

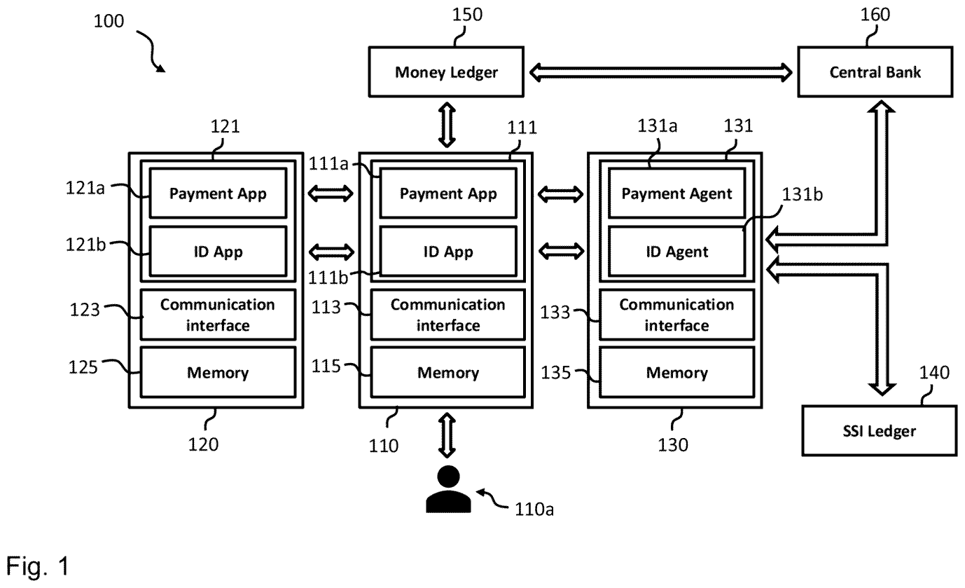

FIG. 1 shows a system 100 for the traceable execution of electronic cashless payments between a first data communication device 110 of a paying user 110a and a second data communication device 120 of a payment recipient. The first and/or the second data communication device 110, 120 may each be a mobile and portable data communication device 110, 120, in particular a smartphone 110, 120. In the examples described below, the data communication devices 110, 120 are exemplary smartphones 110, 120.

In the example shown in FIG. 1, the smartphone 110 of the paying user 110a and the smartphone 120 of the payment recipient each comprise one or more processors 111, 121, a communication interface 113, 123 for wireless and/or wired communication via a communication network and a memory 115, 125 for storing electronic data. The smartphones 110, 120 may each comprise a security element, e.g. a virtual or physical SIM card, which is configured to store security-critical data and/or to execute security-critical operations, in particular cryptographic operations.

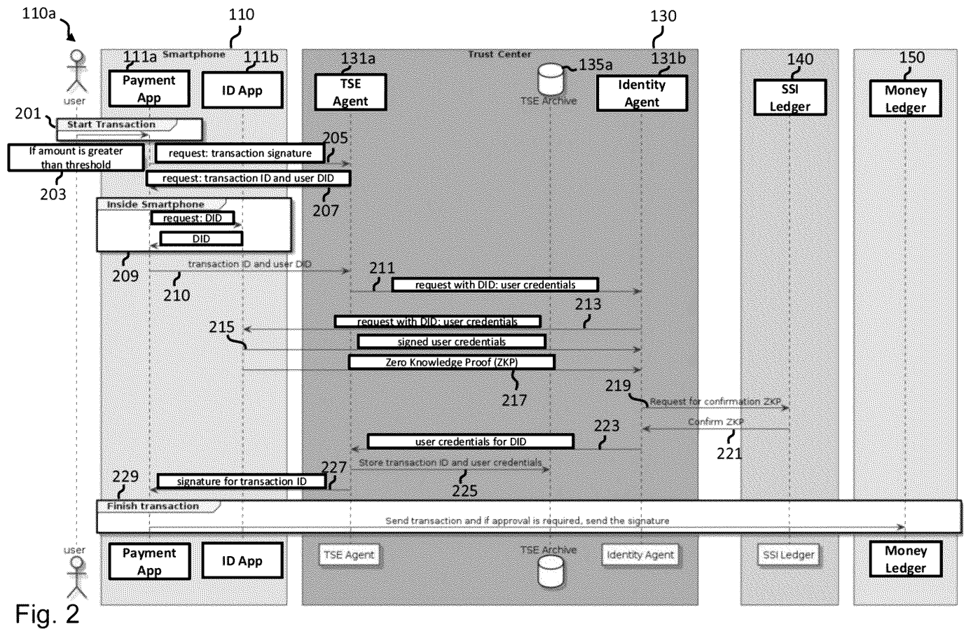

As shown in FIG. 1, the processor 111, 121 of the respective smartphone 110, 120 is configured to execute a payment application 111a, 121a and an ID application or identification application 111b, 121b, the function and interaction of which with one another and with the other components of the system 100 is described in detail below under further reference to FIG. 2.

In addition to the smartphone 110 of the paying user 110a and the smartphone 120 of the payment recipient, the system 100 comprises a trust center server arrangement 130, an ID ledger 140 for self-determined identities (Self-Sovereign Identity (SSI); therefore also referred to as “SSI ledger” 140 in FIG. 1), a money ledger 150, for example a blockchain 150, and a central bank or a central bank server 160 for managing the money ledger 150. The trust center server arrangement 130 may comprise one or more servers with one or more processors 131, a communication interface 133 for wireless and/or wired communication via a communication network and a memory 135 for storing electronic data.

As shown in FIG. 1, the at least one processor 131 of the trust center server arrangement 130 is configured to execute a payment agent 131a (or payment service 131a) and an ID agent 131b (or ID service 131b), the function and interaction of which with one another and with the other components of the system 100 is described in detail below under further reference to FIG. 2.

The money ledger 150 may, for example, be implemented on one or more blockchain servers. In other words: the blockchain servers may be part of a money ledger network 150 and thus be blockchain node(s) of the money ledger 150. The blockchain servers and/or the money ledger 150, i.e. the blockchain network 150, may be managed by a central bank 160, for example. If the central bank 160 is a central bank 160 to which several countries belong, the money ledger 150 may, for example, comprise one or more blockchain servers per country.

FIG. 2 illustrates the interaction of the components of the system 100 shown in FIG. 1 according to an example.

The paying user 110a wants to pay a certain amount to the payment recipient via the payee's smartphone 120 using the paying user's smartphone 110. To do this, in step 201 of FIG. 2, the user 110a starts the payment application 111a (referred to as “payment app” in FIG. 2) on his smartphone 110.

In the example shown in FIG. 2, the payment application 111a implemented by the processor 111 first checks the amount to be paid. If this amount is higher than a threshold value (for example a legally defined threshold value), the smartphone 110 executes the further steps shown in FIG. 2 (step 203 of FIG. 2). Otherwise, i.e. if the amount to be paid is not higher than the threshold value, the payment transaction may be executed without the trust center 130 and be registered on the money ledger 150 in an essentially known manner. However, according to the disclosure, examples are also provided in which this check is omitted and the steps described below are executed regardless of the amount to be paid.

Since in the example shown in FIG. 2 the amount to be paid is greater than the threshold value, the payment application 111a implemented by the processor 111 generates a request in step 205 of FIG. 2 and sends this via the communication interface 113 to the trust center 130, in particular the payment agent 131a (in FIG. 2 identified as “TSE agent” 131a) of the trust center 130, in order to receive a transaction ID digitally signed by the trust center 130. In response to the request in step 205, the payment agent 131a in turn sends a request to the payment application 111a for the transaction ID and a decentralized ID for the user 110a of the smartphone 110 in step 207 of FIG. 2. In an example, the transaction ID may be generated by the payment application 111a of the smartphone.

In the steps 209 of FIG. 2 running within the smartphone 110, the payment application 111a first sends a request to the ID application 111b and receives from it as a response the decentralized ID (DID; also known in English as “Decentralized Identifier”) of the paying user 110a of the smartphone 110.

In step 210 of FIG. 2, the payment application 111a of the smartphone 110 sends the DID received from the ID application 111b and the transaction ID to the payment agent 131a of the trust center 130.

In step 211 of FIG. 2, the payment agent 131a of the trust center 130 sends a request for “user credentials” (or user information) of the user 110a to the ID agent 131b of the trust center 130, wherein the request contains the DID received from the ID application 111b of the smartphone 110. The ID agent 131b essentially serves to automatically verify identities in the SSI ledger (or ID ledger) 140, which is based on the “Distributed Ledger Technology (DLT)”.

In step 213 of FIG. 2, the ID agent 131b of the trust center 130 sends a request for the user credentials to the ID application 111b of the smartphone 110, i.e. for the user information for determining the identity of the user 110a of the smartphone 110 by means of the SSI ledger 140. The request contains the DID originally received from the ID application 111b.

In step 215 of FIG. 2, the ID application 111b of the smartphone 110 signs the user credentials or user information with a private key of the smartphone 110. Such a private key may be stored, for example, in a secure memory area of a security element, for example a virtual or physical SIM card of the smartphone 110. As already described above, security-critical cryptographic operations of the ID application 111b and/or payment application 111a may be executed in such a security element.

In step 217 of FIG. 2, the ID application 111b of the smartphone 110 proves by means of a zero-knowledge proof (ZKP) the authenticity of the credentials or user information transmitted in step 215.

In step 219 of FIG. 2, the ID agent 131b of the trust center 130 obtains data from the ID ledger 140 to confirm or verify the ZKP of step 217 by downloading this data from the ID ledger 140 (step 221 of FIG. 2).

After the ZKP has been confirmed by the ID agent 131b of the trust center 130 (on the basis of which the ID agent 131a may trust the user credentials), the ID agent 131b of the trust center 130 sends the user credentials to the payment agent 131a in step 223 of FIG. 2. The payment agent 131a then stores the signed transaction ID together with the user credentials in a database 135a implemented in the memory 135 (step 225 of FIG. 2). In an example, the payment agent 131a may also assign an identification number for this and link it to the transaction ID.

In step 227, the payment agent 131a of the trust center 130 sends the signed transaction ID to the payment application 111a of the smartphone 110. Thus, step 227 ultimately represents the response of the trust center 130 to the signed transaction ID requested in step 205.

To complete the payment transaction, in step 229 of FIG. 2, the payment application 111a sends the transaction data, i.e. in particular the transaction ID and the amount, as well as the signature of the transaction ID to the money ledger 150, where this data is registered or stored in order to be available to the central bank server 160 for tracking when needed. The payment process is thus completed. Optionally, the identity of the payment recipient, i.e. the user of the further smartphone 120, may also be registered by the payment application 111a also obtaining the DID of the user of the further smartphone 120. In this case, the identity agent 131b of the trust center 130 may establish two separate connections, namely one to the smartphone 110 of the paying user 110a and the other to the smartphone of the payment recipient.

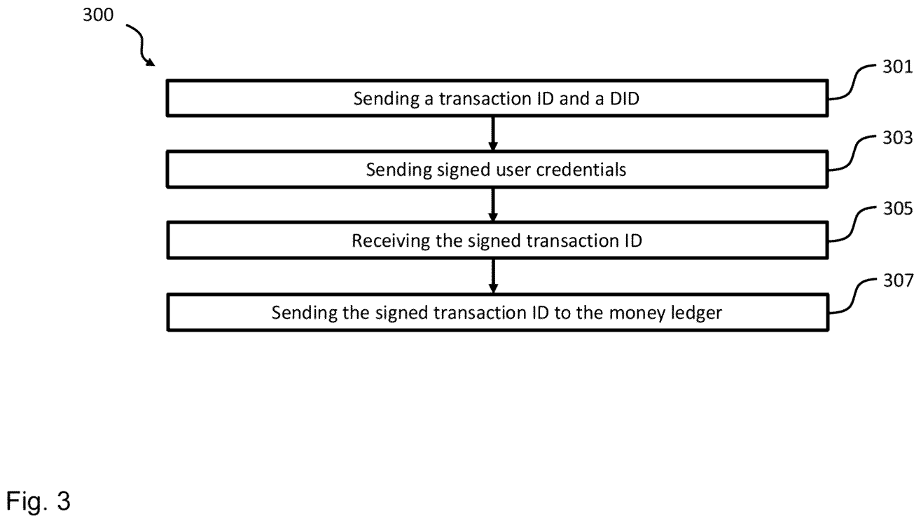

FIG. 3 shows a flow chart illustrating steps of a method 300 for operating the data communication device 110 according to an example. The method 300 comprises the following steps:
sending 301 a transaction ID and a decentralized identity, DID, of the user 110a of the data communication device 110 from the payment application 111a to a payment agent 131a of the trust center server arrangement 130;
sending 303 signed user credentials of the user 110a of the data communication device 110 from the ID application 111b to an ID agent 131b of the trust center server arrangement 130, in response to a request containing the DID from the ID agent 131b of the trust center server arrangement 130;
receiving 305 a signature of the transaction ID from the payment agent 131b of the trust center server arrangement 130 by the payment application 111a; and
sending 307 the signature of the transaction ID from the payment application 111a to the money ledger 150 in order to register the electronic payment transaction with the signature of the transaction ID on the money ledger 150.

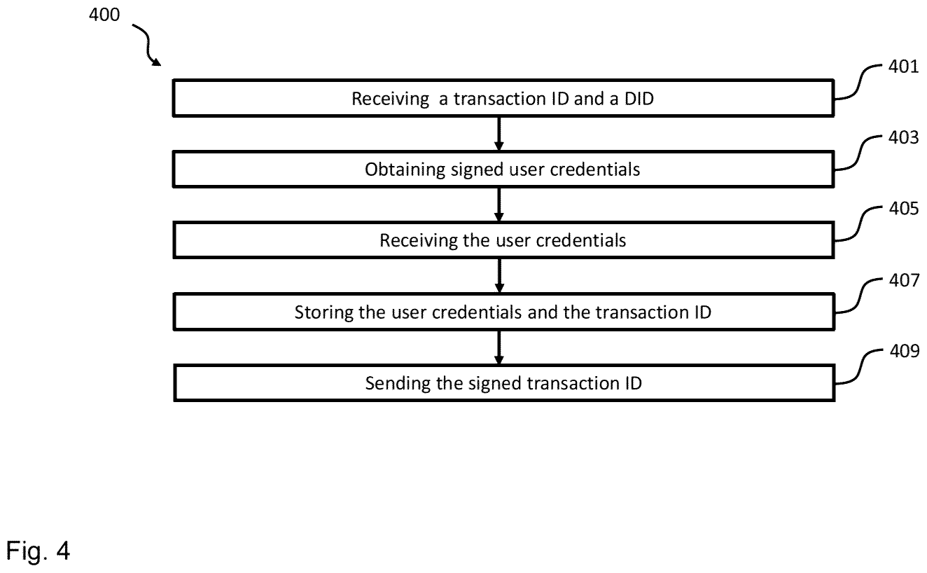

FIG. 4 shows a flow chart illustrating steps of a method 400 for operating the trust center server arrangement 130 according to an example.

The method 400 includes the following steps:
receiving 401 a transaction ID and the decentralized identity, DID, of the user 110a of the data communication device 110 from a payment application 111a of the data communication device 110 by the payment agent 131a;
obtaining 403 signed user credentials of the user 110a of the data communication device 110 from an ID application 111b of the data communication device 110 by the ID agent 131b, in response to a request containing the DID from the payment agent 131a for the user credentials of the user 110a of the data communication device 110;
obtaining 405 the user credentials of the user 110a of the data communication device 110 by the payment agent 131a;
storing 407 the user credentials of the user 110a of the data communication device 110 together with the transaction ID by the payment agent 131a in the memory 135; and sending 409 the signed transaction ID from the payment agent 131a to the payment application 111a of the data communication device 110 in order to be able to register the electronic payment transaction with the signature of the transaction ID on the money ledger 150.

### List of Reference Symbols

100 Electronic payment system
110 Data communication device of the payer
110a Paying User
111 Processor
111a Payment application
111b ID application
113 Communication interface
115 Memory
120 Data communication device of the payee
121 Processor
121a Payment application
121b ID application
123 Communication interface
125 Memory
130 Trust Center Server Arrangement
131 processor
131a Payment Agent
131b ID Agent
133 Communication interface
135 Memory
135a Database
140 ID Ledger
150 Money ledger
160 Central Bank

What is claimed is:

1. A data communication device for executing an electronic payment transaction, wherein the data communication device comprises:
at least one processor, which is configured to execute a payment application and an ID application; and
a communication interface, which is configured to communicate with a trust center server arrangement and a money ledger;
wherein the payment application is configured to send a transaction ID and a decentralized identity, DID, of a user of the data communication device to a payment agent of the trust center server arrangement;
wherein the ID application is configured, in response to a request containing the DID from an ID agent of the trust center server arrangement, to send signed user credentials of the user of the data communication device to the ID agent of the trust center server arrangement;
wherein the payment application is further configured to receive a signature of the transaction ID from the payment agent of the trust center server arrangement and to send the signature of the transaction ID to the money ledger in order to register the electronic payment transaction with the signature of the transaction ID on the money ledger.

2. The data communication device of claim 1, wherein for executing a further electronic payment transaction whose amount is less than a threshold value, the payment application is configured to send a further transaction ID of the further electronic payment transaction without a signature of the further transaction ID to the money ledger in order to register the electronic payment transaction with the further transaction ID and without a signature of the further transaction ID on the money ledger.

3. The data communication device of claim 1, wherein the payment application is further configured to generate the transaction ID and/or to receive the DID of the user of the data communication device from the ID application upon request.

4. The data communication device of claim 1, wherein the ID application is further configured to send zero-knowledge proof data to the ID agent of the trust center server arrangement in response to the request of the ID agent of the trust center server arrangement in order to verify the signed user credentials of the user of the data communication device.

5. The data communication device of claim 1, wherein the payment application is further configured to send a further DID of a further user of a further data communication device together with the transaction ID and the DID of the user of the data communication device to the payment agent of the trust center server arrangement.

6. The data communication device of claim 1, wherein the data communication device is a mobile and portable data communication device.

7. (canceled)

8. A trust center server arrangement for executing an electronic payment transaction, wherein the trust center server arrangement comprises:
at least one processor, which is configured to execute a payment agent and an ID agent;
a communication interface, which is configured to communicate with a data communication device; and
a memory for storing electronic data;
wherein the payment agent is configured to receive a transaction ID and a decentralized identity, DID, of a user of the data communication device from a payment application of the data communication device;
wherein the ID agent is configured, in response to a request from the payment agent containing the DID for user credentials of the user of the data communication device, to obtain the signed user credentials of the user of the data communication device from an ID application of the data communication device;
wherein the payment agent is further configured to obtain the user credentials of the user of the data communication device and to store them together with the transaction ID in the memory; and
wherein the payment agent is further configured to sign the transaction ID and to send the signed transaction ID to the payment application of the data communication device in order to be able to register the electronic payment transaction with the signature of the transaction ID on a money ledger.

9. The trust center server arrangement of claim 8, wherein the communication interface is further configured to communicate with an ID ledger and wherein the ID agent is further configured to receive zero-knowledge proof data from the ID application of the data communication device and to verify the signed user credentials of the user of the data communication device by means of the zero-knowledge proof data and the ID ledger.

10. (canceled)

11. A system for executing an electronic payment transaction, wherein the system comprises:
a plurality of data communication devices, wherein each of the plurality of data communication devices comprises:
at least one processor, which is configured to execute a payment application and an ID application; and
a communication interface, which is configured to communicate with a trust center server arrangement and a money ledger;
wherein the payment application is configured to send a transaction ID and a decentralized identity, DID, of a user of the data communication device to a payment agent of the trust center server arrangement;
wherein the ID application is configured, in response to a request containing the DID from an ID agent of the trust center server arrangement, to send signed user credentials of the user of the data communication device to the ID agent of the trust center server arrangement;
wherein the payment application is further configured to receive a signature of the transaction ID from the payment agent of the trust center server arrangement and to send the signature of the transaction ID to the money ledger in order to register the electronic payment transaction with the signature of the transaction ID on the money ledger; and
a trust center server arrangement comprising:
at least one processor, which is configured to execute a payment agent and an ID agent;
a communication interface, which is configured to communicate with a data communication device; and
a memory for storing electronic data;
wherein the payment agent is configured to receive a transaction ID and a decentralized identity, DID, of a user of the data communication device from a payment application of the data communication device;
wherein the ID agent is configured, in response to a request from the payment agent containing the DID for user credentials of the user of the data communication device, to obtain the signed user credentials of the user of the data communication device from an ID application of the data communication device;
wherein the payment agent is further configured to obtain the user credentials of the user of the data communication device and to store them together with the transaction ID in the memory; and
wherein the payment agent is further configured to sign the transaction ID and to send the signed transaction ID to the payment application of the data communication device in order to be able to register the electronic payment transaction with the signature of the transaction ID on a money ledger.

12. (canceled)

13. The system of claim 11, wherein for executing a further electronic payment transaction whose amount is less than a threshold value, the payment application is configured to send a further transaction ID of the further electronic payment transaction without a signature of the further transaction ID to the money ledger in order to register the electronic payment transaction with the further transaction ID and without a signature of the further transaction ID on the money ledger.

14. The system of claim 11, wherein the payment application is further configured to generate the transaction ID and/or to receive the DID of the user of the data communication device from the ID application upon request.

15. The system of claim 11, wherein the ID application is further configured to send zero-knowledge proof data to the ID agent of the trust center server arrangement in response to the request of the ID agent of the trust center server arrangement in order to verify the signed user credentials of the user of the data communication device.

16. The system of claim 11, wherein the payment application is further configured to send a further DID of a further user of a further data communication device together with the transaction ID and the DID of the user of the data communication device to the payment agent of the trust center server arrangement.

17. The system of claim 11, wherein the data communication device is a mobile and portable data communication device.

18. The system of claim 11, wherein the communication interface of the trust center server arrangement is further configured to communicate with an ID ledger and wherein the ID agent is further configured to receive zero-knowledge proof data from the ID application of the data communication device and to verify the signed user credentials of the user of the data communication device by means of the zero-knowledge proof data and the ID ledger
